(19) United States
(12) Patent Application Publication
(10) Pub. No.: US 2011/0051908 A1
(43) Pub. Date: Mar. 3, 2011

(54) TARGET CONTENT DISTRIBUTION FOR TELEPHONE CALLS

(76) Inventors: Robert Garner, Miami Beach, FL (US); Robert J. Young, Miami Beach, FL (US)

(21) Appl. No.: 12/552,873

(22) Filed: Sep. 2, 2009

(51) Int. Cl. H04M 3/42; H04M 1/64; G06Q 30/00

(52) U.S. Cl. 379/88.04; 379/207.12; 705/14.58; 705/14.71

(57) ABSTRACT

Embodiments of the invention address deficiencies of the art in respect to content delivery over a telephone call and provide a method, system and computer program product for delivering targeted content to a caller during call processing of an inbound telephone call. In an embodiment of the invention, a method for delivering targeted content to a caller during call processing of an inbound telephone call can include receiving a telephone call from a caller in a call handling system and identifying a telephone number for the telephone call from information contained in the telephone call. The method also can include determining a location corresponding to the telephone number and matching the determined location to content stored in a data store of content. Finally, the method can include retrieving the matched content from the data store of content, and delivering the matched content to the caller.

### BACKGROUND OF THE INVENTION

1. Field of the Invention

The present invention relates to the field of call processing for inbound telephone calls and more particularly to targeted content distribution over a telephone call for a caller, such as a caller on hold.

2. Description of the Related Art

Call processing for inbound telephone calls refers to the handling of an inbound telephone call by a called party. In the most simplistic circumstance, a single called extension can receive a telephone call and, upon connection, an established telephone call can permit two-way conversation between the caller and the called party. Enhanced features of the telephone call permit the placement of the caller on hold, or the establishment of a conference call. More advanced, multi-line systems permit the routing of a telephone call to one of multiple different extensions permitted by the multi-line system. Even more advanced call handling systems capitalize on the programmatic handling of inbound calls through the integration of computing resources by way of a call processing gateway between the switched telephone circuits of the public switched telephone network (PSTN) and the computing logic of the computing resources, including a distributed arrangement of computing resources coupled to one another over a data communications network.

Traditional advanced call handling systems include both interactive voice response (IVR) systems and automated call distribution (ACD) systems—both common in call centers and for industrial processing of customer and potential customer telephone calls. An IVR system is an automated call processing system providing self-service interactions with callers through a telephone call. The most basic IVR system provides a sequence of prompts that vary according to caller selections—generally provided in the form of dial tones or spoken choices. More advanced IVR systems handle natural language input from callers in order to properly service caller requests. Even more advanced IVR systems provide an escalation path in which callers ultimately can be routed to a human operator when requested by the caller, or when detected as necessary, but otherwise provide automated responses in the absence of human intervention. ACD systems, by comparison, automatically place a caller on hold while routing an inbound call to an available operator according to routing rules for routing telephone calls.

Both ACD and IVR systems usually include a computing system with a call processing gateway between the computing logic of the IVR or ACD system and the public switched telephone network (PSTN). In this regard, the call processing gateway generally includes hardware configured for coupling to the PSTN and also to a data communications pathway, either through direct bus connection of the computing system, or a packet switched network connection to a remote server. Some IVR and ACD systems include pre-recorded audible responses triggered for playback in response to user input while other ACD and IVR systems process scripts such as Voice Extensible Markup Language (VXML) compliant scripts and dynamically generate audible responses—typically by way of a text-to-speech (TTS) engine or through a combination of TTS and pre-recorded audio. Even more advanced ACD and IVR systems process spoken user input by way of a speech recognition engine in order to properly select a response to a user inquiry.

Generally, inbound calls in an IVR and ACD system are handled irrespective of the identity of the caller. However, some IVR and ACD systems provide call handling based upon the identity of the caller. In this regard, caller identification methods such as the use of automatic number identification (ANI) permit the IVR or ACD system to detect the identity of the caller and to provide customized handling of the telephone call such as the routing of the call to a specific operator or extension, or the automatic loading of caller information in a computing terminal of an operator receiving the call. Yet, some features of IVR and ACD system remain generic to all callers including caller on-hold processing.

Specifically, conventional IVR and ACD systems provide audible playback of music to all callers irrespective of the identity of the caller. Indeed, it has been suggested previously to allow a caller by way of an audible menu selection to choose a type of music to be played while the caller is on hold. Others have suggested allowing callers to select a particular type of game to be played while waiting in a hold queue. Yet, in both instances, the caller must proactively and affirmatively select the type of content to be distributed while waiting in the hold queue.

### BRIEF SUMMARY OF THE INVENTION

Embodiments of the present invention address deficiencies of the art in respect to content delivery over a telephone call and provide a novel and non-obvious method, system and computer program product for delivering targeted content to a caller during call processing of an inbound telephone call. In an embodiment of the invention, a method for delivering targeted content to a caller during call processing of an inbound telephone call can include receiving a telephone call from a caller in a call handling system and identifying a telephone number for the telephone call from information contained in the telephone call. The method also can include determining a location corresponding to the telephone number and matching the determined location to content stored in a data store of content. Finally, the method can include retrieving the matched content from the data store of content, and delivering the matched content to the caller.

In an aspect of the embodiment, determining a location corresponding to the telephone number can include determining an industrial organization name corresponding to the telephone number or an industrial organization type corresponding to the telephone number. In another aspect of the embodiment, the matched content can be an advertisement, or the matched content can be music. In yet another aspect of the embodiment, delivering the matched content to the caller can include placing the caller on hold in a hold queue, and delivering the matched content to the caller while the caller is in the hold queue. Alternatively, delivering the matched content to the caller can include selecting an extension to which the telephone call is to be routed, and delivering the matched content to the caller before routing the telephone call to the selected extension. Finally, as yet another alternative, delivering the matched content to the caller can include selecting an extension to which the telephone call is to be routed, routing the telephone call to the extension, detecting a termination of the telephone call between the caller and the extension, and delivering the matched content to the caller before dropping the telephone call.

In another embodiment of the invention, a call handling data processing system can be provided. The system can include a call handler executing in memory by a processor of a computer, a call processing gateway coupled to the call handler and disposed in the computer and configured for coupling to a PSTN, and a data store of content mapped to different locations associated with different telephone numbers. The system further can include a targeted content delivery module in the memory of the computer. The module can include program code enabled to identify a telephone number for a received telephone call from a caller over the PSTN using information contained in the telephone call, to determine a location corresponding to the telephone number by reference to the data store, to match the determined location to selected content in the data store, to retrieve the matched content from the data store, and to deliver the matched content to the caller.

In an aspect of the embodiment, the call handler can be an IVR system, or alternatively, an ACD system. Further, the content can include advertisements, or music to name a couple of examples. Yet further, the location can be a name of an industrial organization or a type of an industrial organization. Finally, in another aspect of the embodiment, the system can include a hold queue such that the program code of the module can be enabled to deliver the matched content to the caller only while the telephone call has been placed in the hold queue.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for delivering targeted content to a caller during call processing of an inbound telephone call;

FIG. 2 is a schematic illustration of a call handling data processing system configured for delivering targeted content to a caller during call processing of an inbound telephone call; and,

FIG. 3 is a flow chart illustrating a process for delivering targeted content to a caller during call processing of an inbound telephone call.

### DETAILED DESCRIPTION OF THE INVENTION

Embodiments of the present invention provide a method, system and computer program product for delivering targeted content to a caller during call processing of an inbound telephone call. In accordance with an embodiment of the present invention, an inbound telephone call can be received in a call processing gateway of a call handling system. The phone number of the caller can be determined, for example, by way of Caller Identification (Caller ID) or ANI, and the phone number can be matched to a location, such as an industrial organization or type of industrial organization associated with the phone number. Thereafter, targeted content can be retrieved from data store of targeted content matching the location and the targeted content can be provided to the caller, either prior to call routing to an extension, subsequent to call routine to an extension, or while the caller remains in a hold queue. In this way, the caller can receive content in consequence of the call pertinent to the location of the caller without requiring the caller to proactively select the delivery of pertinent content—particularly when the caller is on hold.

In further illustration, FIG. 1 pictorially shows a process for delivering targeted content to a caller during call processing of an inbound telephone call. As shown in FIG. 1, a caller 120A can place a telephone call from a location 110, such as an industrial organization. Examples of industrial organizations include retail stores, service businesses, public transportation terminals and the like. The telephone call can be received in a call processing center 140 from over a PSTN 150. The call processing center 140, such as a public branch exchange (PBX) or a call center in general, can include one or more telephone extensions 180 to which the telephone call can be routed. To facilitate the routing of the telephone call, the call processing center 140 can include an ACD or IVR system (not shown).

The caller phone number 160 of the location 110 can be determined by the call processing center 140, for instance by inspecting ANI data for the telephone call or by requesting the services of Caller ID, as it is well-known in the art. Targeted content delivery system 100 can map the caller phone number 160 to a data store of content 190A, 190B, such as music 190B or advertisements 190B by way of a location/content table 130. Of note, the location/content table 130 can map phone numbers to content with specific reference to a particular phone number, or by reference to a type of industrial organization common to different phone numbers so that once a location type for a phone number has been determined, content can be mapped according to the type of location in general rather than a specific phone number. Optionally, the location/content table 130 can include an additional mapping to a bids provided by advertisers 120B.

Thereafter, the mapped content 170A, 170B can be delivered to the caller 120 over the PSTN 150 only while the caller 120 is on hold, only prior to routing the caller 120 to a specific one of the extensions 180, or subsequent to the routing of the caller 120 to a specific one of the extensions 180 and subsequent to a completion of the telephone call with the specific one of the extensions 180. Optionally, the mapped content 170A, 170B can include content associated with a highest bid provided by the advertisers 120B such that advertisers 120B can bid to provide content to callers calling from specified locations.

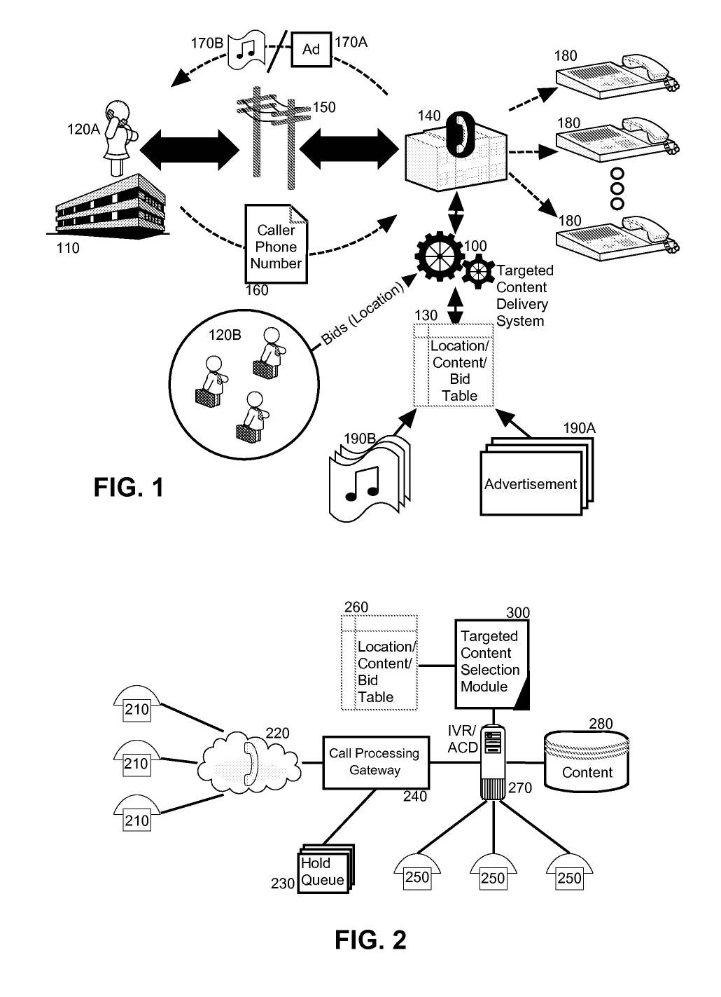

In yet further illustration of the architecture of an implementation of the targeted content delivery system, FIG. 2 is a schematic illustration of a call handling data processing system configured for delivering targeted content to a caller during call processing of an inbound telephone call. The system can include an IVR or ACD system 270 executing in one or more computers with processor and memory. The IVR/ACD system can include a call processing gateway 240 including one or more call processing boards. The call processing gateway 240 in turn can be configured for communicative coupling to different telephones 210 at different geographically remote locations over a PSTN 220. The call processing gateway 240, via the IVR/ACD system 270 further can be configured for communicative coupling to different extensions 250 either over a switched telephone network, or a data communications network through Voice over Internet Protocol (VoIP). Further, the call processing gateway 240 can include a hold queue 230 into which incoming telephone calls from the different telephones 210 can be placed pending routing to an available one of the extensions 250.

A data store of content 280 can be coupled to the IVR/ACD system 270. The content 280 can include different music files, each containing music or other forms of audible entertainment, or advertisement files, each containing audible marketing material. Additionally, a location/content table 260 can be provided. The location/content table 260 can map different phone numbers to different content in the data store of content 280. Alternatively, the location/content table 260 can map different phone numbers to different locations that in turn can be mapped to different content in the data store of content 280. As yet a further alternative, the location/content table 260 can map different phone numbers to different types of locations, such as different types of industrial organizations that in turn can be mapped to different content in the data store of content 280. As yet even a further alternative, the location/content table 260 can map different bids to different types of locations.

Of note, a targeted content selection module 300 can be coupled to the IVR/ACD system 270 and the location/content table 260. The module 300 can include program executing in memory by a processor of a computer also coupled to the IVR/ACD system 270 (and in a simplistic embodiment, can reside in the same computer as the IVR/ACD system 270). The program code of the module 300 can be enabled to determine a phone number for a received telephone call from a telephone 210 over the PSTN 220. The program code of the module 300 further can be enabled to map the phone number to content in the data store of content 280 according to the location/content table 260. Finally, the program code of the module 30 can be enabled to deliver the mapped content to the telephone 210 over the PSTN either while the telephone call is held in the hold queue 230, prior to routing the telephone call to a selected one of the extensions 250, or subsequent to a completion of the telephone call between the telephone 210 and a selected one of the extensions 250.

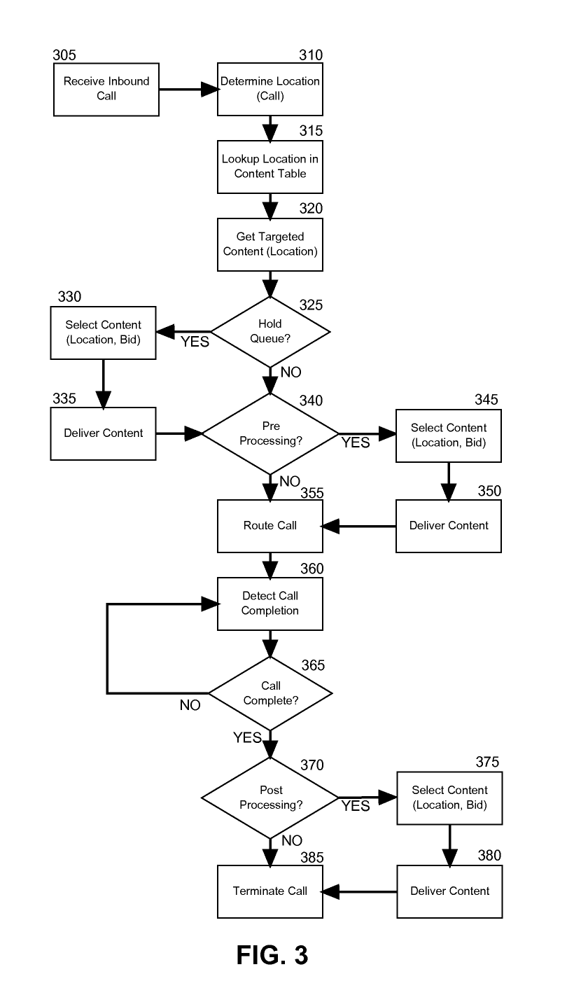

In even yet further illustration of the operation of the targeted content selection module 300, FIG. 3 is a flow chart illustrating a process for delivering targeted content to a caller during call processing of an inbound telephone call. Beginning in block 305, an inbound telephone call can be received and in block 310, a location for the telephone call can be determined, for example by way of Caller ID or ANI. In block 315, content can be located in a location/content table that maps to the determined location, or alternatively that maps to a type of industrial organization corresponding to the determined location. Further, content can be located in the location/content table that reflects a highest bid from a highest bidder to deliver content in association with the determined location. Thereafter, the located content can be retrieved from a data store of content.

In decision block 325, it can be determined whether the retrieved content is to be delivered while the telephone call remains in a hold queue. If so, in block 330 the retrieved content can be delivered over the telephone call while the telephone call remains in the hold queue. In decision block 335, it further can be determined whether or not the located content is to be delivered prior to routing the telephone call to an extension. If so, in block 340 the content can be delivered over the telephone call prior to routing the call to an extension. Subsequently, in block 345 the telephone call can be routed to an extension. Once the telephone call has been routed to an extension, a completion of the telephone call with the extension can be detected. As such, in decision block 355, if the telephone call has completed, in decision block 360 it can be determined whether or not the located content is to be delivered subsequent to the completion of the telephone call with the extension. If so, in block 365 the content can be delivered over the telephone call prior to terminating the telephone call. Finally, in block 370 the telephone call can be terminated.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device). Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A method for delivering targeted content to a caller during call processing of an inbound telephone call, the method comprising:
receiving a telephone call from a caller in a call handling system;
identifying a telephone number for the telephone call from information contained in the telephone call;
determining a location corresponding to the telephone number;
matching the determined location to content stored in a data store of content;
retrieving the matched content from the data store of content; and,
delivering the matched content to the caller.

2. The method of claim 1, wherein determining a location corresponding to the telephone number, comprises determining an industrial organization name corresponding to the telephone number.

3. The method of claim 1, wherein determining a location corresponding to the telephone number, comprises determining an industrial organization type corresponding to the telephone number.

4. The method of claim 1, wherein the matched content is an advertisment.

5. The method of claim 4, wherein the advertisement is an advertisement provided by an advertiser placing a highest bid to deliver content for the determined location.

6. The method of claim 1, wherein the matched content is music.

7. The method of claim 1, wherein delivering the matched content to the caller, comprises:
placing the caller on hold in a hold queue; and,
delivering the matched content to the caller while the caller is in the hold queue.

8. The method of claim 1, wherein delivering the matched content to the caller, comprises:
selecting an extension to which the telephone call is to be routed; and,
delivering the matched content to the caller before routing the telephone call to the selected extension.

9. The method of claim 1, wherein delivering the matched content to the caller, comprises:
selecting an extension to which the telephone call is to be routed;
routing the telephone call to the extension;
detecting a termination of the telephone call between the caller and the extension; and,
delivering the matched content to the caller before dropping the telephone call.

10. A call handling data processing system comprising:
a call handler executing in memory by a processor of a computer;
a call processing gateway coupled to the call handler and disposed in the computer and configured for coupling to a public switched telephone network (PSTN);
a data store of content mapped to different locations associated with different telephone numbers; and,
a targeted content delivery module in the memory of the computer, the module comprising program code enabled to identify a telephone number for a received telephone call from a caller over the PSTN using information contained in the telephone call, to determine a location corresponding to the telephone number by reference to the data store, to match the determined location to selected content in the data store, to retrieve the matched content from the data store, and to deliver the matched content to the caller.

11. The system of claim 10, wherein the call handler is an interactive voice response (IVR) system.

12. The system of claim 10, wherein the call handler is an automatic call distribution (ACD) system.

13. The system of claim 10, wherein the content comprises advertisements.

14. The system of claim 10, wherein the content comprises music.

15. The system of claim 10, wherein the location is a name of an industrial organization.

16. The system of claim 10, wherein the location is a type of an industrial organization.

17. The system of claim 10, further comprising a hold queue, and wherein the program code of the module is enabled to deliver the matched content to the caller only while the telephone call has been placed in the hold queue.

18. A computer program product comprising a computer usable medium embodying computer usable program code for delivering targeted content to a caller during call processing of an inbound telephone call, the computer program product comprising:
computer usable program code for receiving a telephone call from a caller in a call handling system;
computer usable program code for identifying a telephone number for the telephone call from information contained in the telephone call;
computer usable program code for determining a location corresponding to the telephone number;
computer usable program code for matching the determined location to content stored in a data store of content;
computer usable program code for retrieving the matched content from the data store of content; and,
computer usable program code for delivering the matched content to the caller.

19. The computer program product of claim 18, wherein the computer usable program code for determining a location corresponding to the telephone number, comprises computer usable program code for determining an industrial organization name corresponding to the telephone number.

20. The computer program product of claim 18, wherein the computer usable program code for determining a location corresponding to the telephone number, comprises computer usable program code for determining an industrial organization type corresponding to the telephone number.

21. The computer program product of claim 18, wherein the matched content is an advertisement.

22. The computer program product of claim 21, wherein the advertisement is an advertisement provided by an advertiser placing a highest bid to deliver content for the determined location.

23. The computer program product of claim 18, wherein the matched content is music.

24. The computer program product of claim 18, wherein the computer usable program code for delivering the matched content to the caller, comprises:
computer usable program code for placing the caller on hold in a hold queue; and,
computer usable program code for delivering the matched content to the caller while the caller is in the hold queue.

25. The computer program product of claim 18, wherein the computer usable program code for delivering the matched content to the caller, comprises:
computer usable program code for selecting an extension to which the telephone call is to be routed; and,
computer usable program code for delivering the matched content to the caller before routing the telephone call to the selected extension.

26. The computer program product of claim 18, wherein the computer usable program code for delivering the matched content to the caller, comprises:
computer usable program code for selecting an extension to which the telephone call is to be routed;
computer usable program code for routing the telephone call to the extension;
computer usable program code for detecting a termination of the telephone call between the caller and the extension; and,
computer usable program code for delivering the matched content to the caller before dropping the telephone call.
